(19) United States
(12) Patent Application Publication
(10) Pub. No.: US 2026/0360681 A1
(43) Pub. Date: Nov. 12, 2026

(54) METHODS AND SYSTEMS FOR AUTOMATED CONTROL OF SAMPLING EVENTS

(71) Applicant: DH Technologies Development Pte. Ltd., Singapore (SG)

(72) Inventors: Heguang JI, Singapore (SG); Jing MA, Singapore (SG); Chang LIU, Richmond Hill (CA)

(73) Assignee: DH Technologies Development Pte. Ltd., Singapore (SG)

(21) Appl. No.: 19/139,734

(22) PCT Filed: Dec. 15, 2023
(86) PCT No.: PCT/IB2023/062816

§ 371 Date: Jun. 16, 2025

Related U.S. Application Data
(60) Provisional application No. 63/476,088, filed on Dec. 19, 2022.

(51) Int. Cl. H01J 49/04; H01J 49/00

(52) U.S. Cl. CPC H01J 49/045; H01J 49/0027

(57) ABSTRACT

Methods and systems for automatically controlling a sampling event, the methods and systems including performing a sampling trigger A corresponding to a triggering time A (511), ejecting a sample A from a sample source, wherein the sample ejection A corresponds to a sampling time A (530), determining a delay time based on the sampling time A and a sampling time B of a previous sample B, and performing a sampling trigger C, wherein the sampling trigger C is performed based at least in part on the delay time. This allows to increase the rate of high throughput mass spectrometry while avoiding the problem of potential signal overlapping.

### CROSS-REFERENCE TO RELATED APPLICATION

This application is being filed on Dec. 15, 2023, as a PCT International Patent Application that claims priority to and the benefit of U.S. Provisional Application No. 63/476,088, filed on Dec. 19, 2022, which is hereby incorporated by reference in its entirety.

### BACKGROUND

A wide variety of sampling events operate based on the time stamps of trigger signals. For instance, examples of sampling events that operate based on the time stamps of trigger signals include, but are not limited to, sample ejection, sample contact, and/or sample emission.

### SUMMARY

As used herein, capital letters “A”, “B”, and “C” (for example, as used in the phrase “sampling trigger A”, “sample C”, etc.) are utilized to assocaite a sampling trigger with a corresponding triggering time, sample, sampling time, and other events, aspects, or criteria. The use of capital letters “A”, “B”, and “C” does not necessarily imply an order in which certain actions take place. Similarly, as used herein, the terms “first”, “second”, “third”, are utilized to relate similar events, aspects, and criteria and do not necessarily imply an order of performance. In some embodiments, the sampling trigger sequence may be “sampling trigger B”, “sampling trigger A” and “sampling trigger C”. In some embodiments, the sampling trigger sequence may be “sampling trigger A” and “sampling trigger C”.

In one aspect of the present disclosure, a method for automatically controlling a sampling event, the method including performing a sampling trigger A corresponding to a triggering time A, ejecting a sample A from a sample source, wherein the sample ejection A corresponds to a sampling time A, determining a delay time based on the sampling time A and a sampling time B, and performing a sampling trigger C, wherein the sampling trigger C is performed based at least in part on the delay time.

In various examples of the above aspect, the sampling trigger C is performed after the delay time from the triggering time A. In yet another example, determining a delay time includes calculating a difference between the sampling time A to the sampling time B, and determining the delay time based on the difference. In another example, determining the delay time based on the difference includes comparing the difference and a preset threshold, and setting the delay time based on the comparison of the difference and the preset threshold. In a further example, the delay time is at least equal to a preset threshold. In other examples, the sampling time B corresponds to a sample ejection B, wherein the sample ejection B is performed before the sample ejection A. In other examples, the sampling trigger B is performed before the sample ejection B. In other examples, the sampling time B is a reference sampling time. In other examples, the method further includes optimizing an acoustic energy A after performing the sampling trigger A. In other examples, the sample A is ejected after the acoustic energy optimization A. In other examples, a difference between the triggering time C and the sampling time A is a constant.

In another aspect of the present disclosure, a sampling event controlling system includes a sample ejector for ejecting a sample from a sample source, a processor operatively coupled to the sample ejector, and a memory coupled to the processor. In various examples, the memory stores instructions that, when executed by the processor, perform a set of operations. In examples, the set of operations includes performing, via the processor, a sampling trigger A corresponding to a triggering time A, ejecting, via the sample ejector, a sample A from a sample source, wherein the sample ejection A corresponds to a sampling time A, determining, via the sample ejector, a delay time based on the sampling time A and a sampling time B, and performing, via the processor, a sampling trigger C, wherein the sampling trigger C is performed based at least in part on the delay time.

In various examples of the above aspect, the sampling trigger C is performed after the delay time from the triggering time A. In yet another example, the set of operations includes determining a delay time by determining a delay time includes calculating a difference between the sampling time A to the sampling time B, and determining the delay time based on the difference. In another example, the set of operations includes determining the delay time based on the difference by comparing the difference and a preset threshold, and setting the delay time based on the comparison of the difference and the preset threshold. In a further example, the delay time is at least equal to a preset threshold. In other examples, the sampling time B corresponds to a sample ejection B, wherein the sample ejection B is performed before the sample ejection A. In other examples, the set of operations includes performing the sampling trigger B before the sample ejection B. In other examples, the sampling time B is a reference sampling time. In other examples, the set of operations further includes optimizing an acoustic energy A after performing the sampling trigger A. In other examples, the set of operations includes ejecting the sample A after the acoustic energy optimization A. In other examples, a difference between the triggering time C and the sampling time A is a constant. In other examples, the system further includes a clock module for perform the sampling trigger. In other examples, the clock module includes at least one clock circuit.

The details of one or more techniques are set forth in the accompanying drawings and the description below. Other features, objects, and advantages of these techniques is apparent from the description, drawings, and claims.

### BRIEF DESCRITION OF THE DRAWINGS

FIG. 1 is schematic diagram illustrating one exemplary mass analysis system in accordance with various aspects and examples of the present disclosure.

FIG. 2 is schematic diagram illustrating another exemplary mass analysis system in accordance with various aspects and examples of the present disclosure.

FIG. 3 depicts a schematic view of an example system combining an acoustic droplet ejection system with a sampling interface and an ion source.

FIG. 4 is a schematic diagram illustrating one particular example of the computing device in accordance with various aspects and examples of the present disclosure.

FIG. 5 is a diagram illustrating a timing waveform of sampling events, in accordance with various examples of the present disclosure.

FIG. 6 is a diagram illustrating a timing waveform of delayed sampling events, in accordance with various examples of the present disclosure.

FIG. 7 is a table illustrating time stamps of sampling events, in accordance with various examples of the present disclosure.

FIG. 8 is a table illustrating time stamps of another sampling events, in accordance with various examples of the present disclosure.

FIG. 9-10 represent flowcharts illustrating a method for automatically controlling a sampling event, in accordance with various examples of the disclosure.

Before one or more examples of the present teachings are described in detail, one skilled in the art will appreciate that the present teachings are not limited in their application to the details of construction, the arrangements of components, and the arrangement of steps set forth in the following detailed description or illustrated in the drawings. Also, it is to be understood that the terminology used herein is for the purpose of description and should not be regarded as limiting.

### DETAILED DESCRIPTION

### Selected Definitions

For the purposes of interpreting this specification, the following definitions will apply and whenever appropriate, terms used in the singular will also include the plural and vice versa. The definitions set forth below shall supersede any conflicting definitions in any documents incorporated herein by reference.

As used herein, the singular forms “a,” “an,” and “the,” include both singular and plural referents unless the context clearly dictates otherwise.

The terms “comprising,” “comprises,” and “comprised of” as used herein are synonymous with “including,” “includes,” or “containing,” “contains,” and are inclusive or open-ended and do not exclude additional, non-recited members, elements or method steps. It is appreciated that the terms “comprising,” “comprises,” and “comprised of” as used herein comprise the terms “consisting of,” “consists,” and “consists of.”

The recitation of numerical ranges by endpoints includes all numbers and fractions subsumed within the respective ranges, as well as the recited endpoints.

Whereas the terms “one or more” or “at least one”, such as one or more or at least one member(s) of a group of members, is clear per se, by means of further exemplification, the term encompasses inter alia a reference to any one of said members, or to any two or more of said members, such as, e.g., any ≥3, ≥₄, ≥5, ≥6, or ≥7, etc. of said members, and up to all said members.

Unless otherwise defined, all terms used in the present disclosure, including technical and scientific terms, have the meaning as commonly understood by one of ordinary skill in the art to which this disclosure belongs. By means of further guidance, term definitions are included to better appreciate the teaching of the present disclosure.

Timing in digital circuits refers to the relationship of one or more signals in time and phase, i.e., “sampling timing” refers to the time points at which to sampling in order to get the desired or best result. “Time stamp” is a sequence of characters or encoded information identifying when a certain event occurred, usually giving date and time of day, sometimes accurate to a small fraction of a second or a millisecond.

As used herein, the terms “optimize”, “optimization”, or similar, refer to improvements in the acoustic ejection process, whether those improvements achieve a “optimized” or other “idealized” state or condition.

As used herein, capital letters “A”, “B”, and “C” (for example, as used in the phrase “sampling trigger A”, “sample C”, etc.) are utilized to associate a sampling trigger with a corresponding triggering time, sample, sampling time, and other events, aspects, or criteria. The use of capital letters “A”, “B”, and “C” does not necessarily imply an order in which certain actions take place. Similarly, as used herein, the terms “first”, “second”, “third”, are utilized to relate similar events, aspects, and criteria and do not necessarily imply an order of performance. In some embodiments, the sampling trigger sequence may be “sampling trigger B”, “sampling trigger A” and “sampling trigger C”. In some embodiments, the sampling sequence trigger may be “sampling trigger A” and “sampling trigger C”.

In the following passages, different aspects of the present disclosure are defined in more detail. Each aspect so defined may be combined with any other aspect or aspects unless clearly indicated to the contrary.

Reference throughout this specification to “one example” or “an example” means that a particular feature, structure or characteristic described in connection with the example is included in at least one example of the present disclosure. Thus, appearances of the phrases “in one example” or “in an example” in various places throughout this specification are not necessarily all referring to the same example, but may. Furthermore, the particular features, structures or characteristics may be combined in any suitable manner, as would be apparent to a person skilled in the art from this disclosure, in one or more examples. Furthermore, while some examples described herein include some but not other features included in other examples, combinations of features of different examples are meant to be within the scope of the disclosure, and form different examples, as would be understood by those in the art. For example, in the appended claims, any of the claimed examples can be used in any combination.

In the present disclosure, reference is made to the accompanying drawings that form a part hereof, and in which are shown by way of illustration only of specific examples in which the present disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims.

### System for Mass Spectrometry

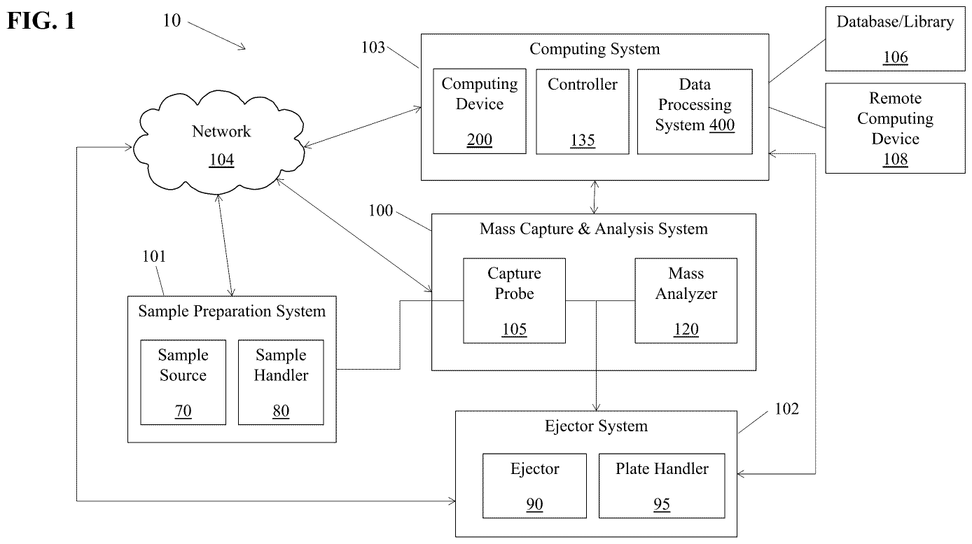

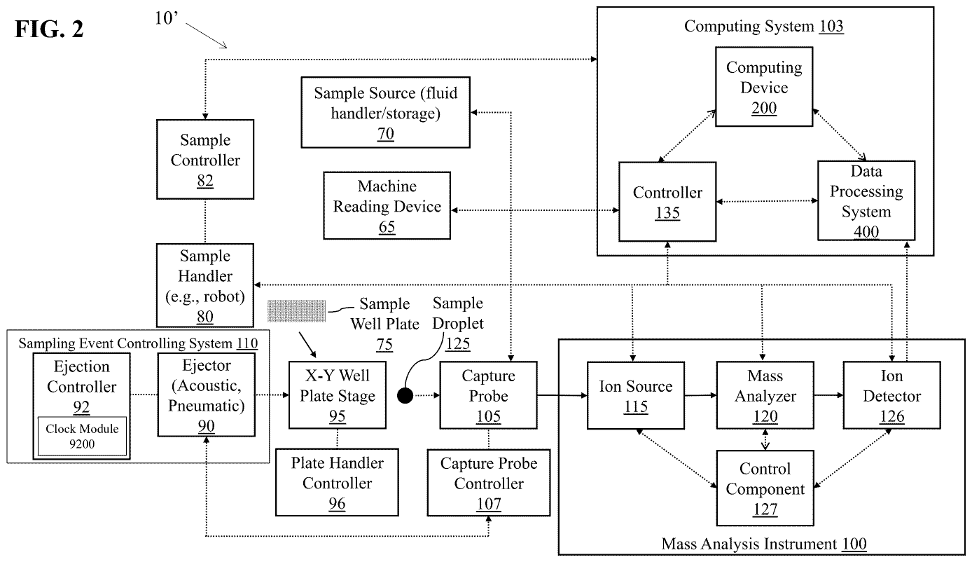

Now referring to FIGS. 1 and 2, examples of the present disclosure are illustrated and described. The descriptions of FIGS. 1 and 2 are concurrent unless otherwise noted. In the illustrated examples, the system 10 or 10′ can each include, in various combinations, pluralities of components, including some or all of: a mass capture and analysis system 100, a sample preparation system 101, an ejector system 102, a computing system 103, a network 104, a database/library 106, and a remote computing device 108. In the example illustrated in FIG. 1, various systems 100, 101, 102, 103, 104, and 106 are subsystems of the system 10 and may be operably connected between or among each other. For example, the computing system 103 is in bilateral communication with the mass capture and analysis system 100, and is also in bilateral communication with the ejector system 102; the sample preparation system 101 is in communication with the mass capture and analysis system 100, and is also in communication with the ejector system 102; the mass capture and analysis system 100 is in communication with the ejector system 102; and the database 106 and the remote computing device 108 are each in communication with the computing system 103.

In some examples, the mass capture and analysis system 100 may be a mass analysis instrument 100. The mass capture and analysis system 100 may be a mass spectrometer system including a mass analyzer 120 for analyzing ions generated from ionization of a sample. The mass capture and analysis system 100 may also include a capture device or probe 105 that captures the sample and provides the sample to other components of the mass capture and analysis system 100. In other examples (such as shown in FIG. 2), the capture probe 105 may be located externally from the mass analysis instrument 100. For instance, the capture probe 105 may be part of the ejection system 102.

It will also be appreciated by a person skilled in the art and in light of the teachings herein that the mass analyzer 120 can have a variety of configurations. Generally, the mass analyzer 120 is configured to process (e.g., filter, sort, dissociate, detect, etc.) sample ions generated by the ion source 115. By way of non-limiting example, the mass analyzer 120 can be a triple quadrupole mass spectrometer, or any other mass analyzer known in the art and modified in accordance with the teachings herein. Other non-limiting, exemplary mass spectrometer systems that can be modified in accordance with various aspects of the systems, devices, and methods disclosed herein can be found, for example, in an article entitled “Product ion scanning using a Q-q-Q linear ion trap (Q TRAP) mass spectrometer” (James W. Hager and J. C. Yves Le Blanc; Rapid Communications in Mass Spectrometry; 2003; 17: 1056-1064); and U.S. Pat. No. 7,923,681, the disclosures of which are hereby incorporated by reference herein in their entireties.

Other configurations, including but not limited to those described herein and others known to those skilled in the art, can also be utilized in conjunction with the systems, devices, and methods disclosed herein. For instance, other suitable mass spectrometers include single quadrupole, triple quadrupole, time-of-flight (ToF), trap, and hybrid analyzers. It will further be appreciated that any number of additional elements can be included in the system 100 including, for example, an ion mobility spectrometer (e.g., a differential mobility spectrometer) that is disposed between the ionization source 115 and the mass analyzer detector 120 and is configured to separate ions based on their mobility difference between in high-field and low-field ). Additionally, it is appreciated that the mass analyzer 120 can include a detector 126 that can detect the ions that pass through the analyzer 120 and can, for example, supply a signal indicative of the number of ions per second that are detected.

The sample preparation system 101 may include a sample source 70 and a sample handler 80. The sample source 70 and a sample handler 80 are operative to retrieve collections of samples from the sample source(s) and to deliver the retrieved collections to capture locations associated with sample capture probes 105. The systems may be operative to independently capture selected ones of the pluralities of samples at the capture locations from the pluralities of samples, to optionally dilute the samples and to transfer the captured samples to mass analysis instruments 100, 120 for mass analysis. In some examples, the sample source 70 may include a set of well plates in a storage housing and/or liquid for adding to well plates. The sample source 70 may include part of a liquid handling system that manipulates and/or injects liquid into the well plates. The sample handler 80 includes one or more electro-mechanical devices (e.g., robotics, conveyor belts, stages, etc.) that are capable of transferring the samples (e.g., well plates) from the sample source to other components of the sample preparation system 101 and/or to other systems, such as the ejection system 102 and/or the capture probe 105. As an example, the sample handler 80 may transfer a well plate from the sample preparation system 101 to the ejection system 102. More specifically, the sample handler 80 may transfer the well plate to a plate handler 95 of the ejection system 102. Accordingly, the sample preparation system 101 may also be referred to as a sample delivery system. In some examples, selected sample information (e.g. sample or compound ID, chemical structure of the target compound, or other sample information) could be obtained during the sample handling steps through the use of sample controller 82 and/or the sample handler 80, and communicated to the computing system 103 or the data processing system 400 thereof.

In addition to the plate handler 95, the ejection system 102 may include an ejector 90 that ejects droplets from the wells of the well plates. The ejector 90 may be any type of suitable ejector, such as an acoustic ejector, a pneumatic ejector, or other type of contactless ejector. In an example, the plate handler 95 receives a well plate from the sample handler 80. The plate handler 95 transports the plate to a capture location that may be aligned with the capture probe 105. Once in the capture location, the ejector 90 ejects droplets from one or more wells of the well plates. The plate handler 95 may include one or more electro-mechanical devices, such as a translation stage that translates the well plate in an x-y plane to align wells of the well plate with the ejector 90 and/or the capture probe 105.

The computing system 103 includes computing resources, components, and modules that are operative to perform various functions including but not limited to: communicating with other subsystems, receiving and transmitting electrical signals with other subsystems or components thereof, receiving, responding to, and executing user instructions, performing calculations, processing raw data received from mass analyzer, performing splitting data, performing sample-dataset correlation, generating and analyzing mass spectrometry data, identifying, annotating, and assigning mass spectrometry (MS) peaks of mass spectra, extracting spectral features from mass spectra, conducting library search, identifying analytes, and outputting analytical report to end users.

In some examples, the computing system 103 includes a computing device 200, a controller 135, and a data processing system 400. The computing device 200 may be in the form of electronic signal processors and operative to perform various computing functions. The controller 135 may be in the form of electronic signal processors and in electrical communication with other subsystems within the system 10 or 10′. The controller 135 is further configured to coordinate some or all of the operations of the pluralities of the various components of the system 10 or 10′. The data processing system 400 may include various components and modules operative to process mass spectrometry data and to provide real-time feedback to end users and other subsystems.

In some examples, a network 104 may be operably connected to any one or all of the subsystems or components in the system 10 or 10′. The network 104 is a communication network. In the example, the network 104 is a wireless local area network (WLAN). The network 104 may be any suitable type of network and/or a combination of networks. The network 104 may be wired or wireless and of any communication protocol. The network 104may include, without limitation, the Internet, a local area network (LAN), a wide area network (WAN), a wireless LAN (WLAN), a mesh network, a virtual private network (VPN), a cellular network, and/or any other network that allows system 104 to operate as described herein.

In some examples, the system 10 or 10′ may further include one or more library/database 106. The database 106 can be a commercial database, or a private database containing analytical information from previously analyzed samples, or a combination of both. The library/database 106 includes chemical knowledge of standard of known compounds stored therein, including but not limited to chemical formula or elemental composition, neutral mass, monoisotopic mass, or mass of internal fragments thereof. In some examples, the computer system 103 is operative to perform a search using the database 106 and/or to compare data produced by the data processing system 400 to the retrieved data from the database 106 (such as molecular mass information or spectral features) to facilitate mass analysis and/or analyte identification.

Also illustrated in FIG. 2 are components of a sample delivery system for use in combination with the mass analysis instrument 100. The sample delivery system includes at least a sample source 70 for supplying a plurality of samples, a sample handler 80 for delivering the plurality of samples to a capture location, and a capture probe 105 for independently capturing one or more samples of the plurality of samples. In some aspects, the sample delivery system may further include a stage 95 for locating each sample for the plurality of samples proximate to a capture surface of the capture probe 105 and an ejector 90 for selectively ejecting that located sample into the capture surface of the capture probe.

In operation, a sample delivery system (including sample source 70 and sample handler 80) can iteratively deliver independent samples from a plurality of samples (e.g., a sample from a well of a well plate 75) to the capture probe 105. The capture probe 105 can dilute and transport each such delivered sample to the ion source 115 disposed downstream of the capture probe 105 for ionizing the diluted sample. A mass analyzer 120 can receive generated ions from the ion source 115 for mass analysis. The mass analyzer 120 is operative to selectively separate ions of interest from generated ions received from the ion source 115 and to deliver the ions of interest to an ion detector 126 that generates a mass spectrometer signal indicative of detected ions to the data processing system 400. In some aspects, the separate ions of interest may be indicated in an analysis instruction associated with that sample. In some aspects, the separate ions of interest may be indicated in an analysis instruction identified by an indicia physically associated with the plurality of samples.

In some aspects, the system 10 or 10′ may further include the generation, assignment, and use of identifiers associated with collections of samples and/or individual samples, and incorporation by one or more of components 70, 80, 95, 105, 100, etc. of identifier readers. For instance, an identifier associated with a well plate may be read or scanned by a machine reading device 65 as it leaves the sample source 70 and/or when the well plate is received by the stage 95. In such aspects, the identifier(s) may be used by the system to associate a corresponding one or more sets of instructions for use by the mass analysis instrument 100, 120 when analyzing transported sample droplets 125. In some aspects, the identifier may include an indicia physically associated with the plurality of samples. In some aspects, the indicia may be readable by optical, electrical, magnetic or other non-contact reading means. Indicia or identifiers in accordance with such aspects of the disclosure can include any characters, symbols, or other devices suitable for use in adequately identifying samples, sample collections, and/or handling or analysis instructions suitable for use in implementing the various aspects and examples of the present disclosure.

Additional details regarding implementation and operation of system 10 or 10′ in accordance with various aspects and examples of the present disclosure can be explained with reference to the Figures. FIGS. 1 and 2 present system diagrams illustrating examples of a system 10 or 10′, each example including a sample handler 80 and an associated controller 135, which may be, for example, a Biomek computer available from Beckman Coulter Life Sciences, is in operative communication with a mass analysis instrument 100 and a controller for the capture probe 105, which may include, for example, an a SciexOS® computer available from Sciex. The Analyst® or SciexOS® computer includes a control component 107 for the capture probe 105, represented for example by Sciex open port probe (OPP) (also referred to as an open port interface (OPI)) software, and a control component 127 for the mass analysis instrument 100, which may be the Analyst® computer. The mass analysis instrument 100 and capture probe controller 107 may be further in operative communication with an ejector 90 and an X-Y Well Plate Stage 95 and plate handler controller 96, which may be, for example, a liquid droplet ejector with embedded computer or processor. For the purposes of this application, these distributed controller components may collectively be considered to be a system controller, and depending upon the configuration may be centralized, or distributed as is the case here. For instance, one of the controllers or controller components may send signals to the other controllers to control the respective devices.

### System for Sample Ejection

Now referring to FIGS. 1 and 2, examples of the sample ejection system are illustrated and described. In the illustrated examples, the sampling event control system can include, in various combinations, pluralities of components, including some or all of a sample preparation system 101, an ejector system 102, a computing system 103, a network 104, a database/library 106, and a remote computing device 108. In certain aspects, the ejector system 102 includes an ejector which generates a controllable stream of droplets of fluid. Fluid includes without limitation, suspensions or emulsions which have viscosities in a range capable of droplet formation using an ejection mechanism.

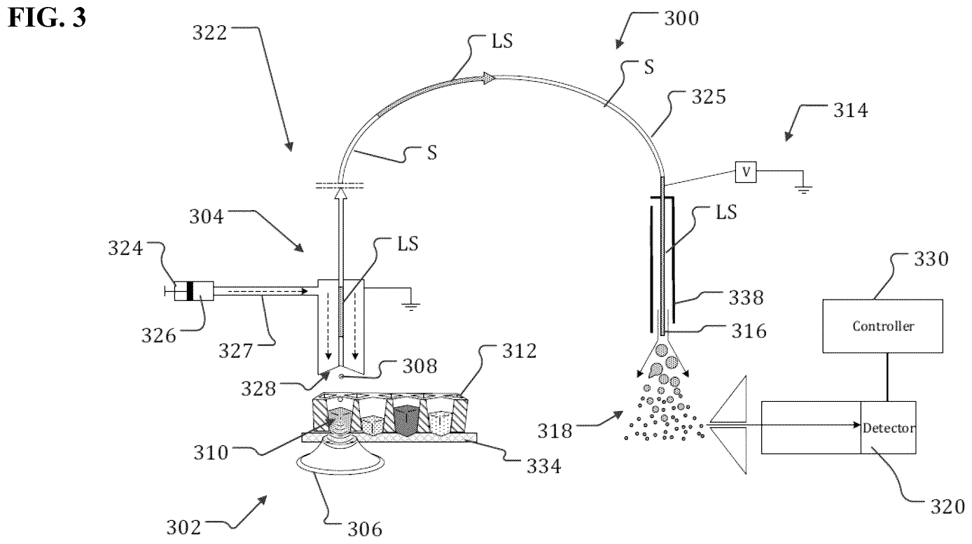

FIG. 3 depicts a schematic view of an example acoustic ejection mass spectrometry (AEMS) system 300 combining an acoustic droplet ejection (ADE) device 302 with an open port interface (OPI) 304 and an ESI device source 314. The system 300 provides an example of an integration and physical connection between the ejection system 102, the capture probe 105, and the mass analysis instrument 100.

The ADE 302 includes an acoustic ejector 306 that is configured to eject a droplet 308 from a reservoir 312 into the open end of a sample receiver such as, e.g., sampling OPI 304. The acoustic ejector 306 is one example of the ejector 90, and the sampling OPI 304 is one example of the capture probe 105. As shown in FIG. 3, the example system 300 generally includes the sampling OPI 304 in liquid communication with the ESI source 314 for discharging a liquid containing one or more sample analytes (e.g., via electrospray electrode 316) into an ionization chamber 318, and a mass analyzer detector (depicted generally at 320) in communication with the ionization chamber 318 for downstream processing and/or detection of ions generated by the ESI source 314. The ESI source 314 is an example of the ion source 115, and the mass analyzer detector 320 is an example of the ion detector 126.

Due to the configuration of the nebulizer probe 338 and electrospray electrode 316 of the ESI source 314, samples ejected therefrom are in the gas phase. A liquid handling system 322 (e.g., including one or more pumps 324 and one or more conduits 325) provides for the flow of a transport liquid from a solvent reservoir 326 to the sampling OPI 304 and from the sampling OPI 304 to the ESI source 314. The solvent reservoir 326 (e.g., containing a liquid, desorption solvent) can be liquidly coupled to the sampling OPI 304 via a supply conduit 327 through which the transport liquid can be delivered at a selected volumetric rate by the pump 324 (e.g., a reciprocating pump, a positive displacement pump such as a rotary, gear, plunger, piston, peristaltic, diaphragm pump, or other pump such as a gravity, impulse, pneumatic, electrokinetic, and centrifugal pump), all by way of non-limiting example. The flow of transport liquid into and out of the sampling OPI 304 occurs within a sample space accessible at the open end such that one or more droplets 308 can be introduced into the liquid boundary 328 at the sample tip and subsequently delivered to the ESI source 314.

The ADE 302 is configured to generate acoustic energy that is applied to a liquid contained within a well or reservoir 310 of a well plate 312 that causes one or more droplets 308 to be ejected from the reservoir 310 into the open end of the sampling OPI 304. The well plate 312 is an example of the well plates 75 discussed above. The acoustic energy is generated from an acoustic ejector 306, which is an example of the ejector 90 discussed above. The well plate 312 may reside on a movable stage 334, which is an example of the plate stage 95 discussed above.

A controller 330 can be operatively coupled to the ADE 302 and can be configured to operate any aspect of the ADE 302 (e.g., focusing structures, acoustic ejector 306, automation elements for moving a movable stage 334 so as to position a reservoir 310 into alignment with the acoustic ejector 306 and/or the OPI 304, etc.). This enables the ADE 302 to eject droplets 308 into the sampling OPI 304 as otherwise discussed herein substantially continuously or for selected portions of an experimental protocol by way of non-limiting example. Controller 330 can be, but is not limited to, a microcontroller, a computer, a microprocessor, or any device capable of sending and receiving control signals and data. Wired or wireless connections between the controller 330 and the remaining elements of the system 300 are not depicted but would be apparent to a person of skill in the art. The controller 330 may be any of the controllers discussed above and may be responsible for controlling the mass analysis instrument 100 and/or the sample delivery system 101 as well.

As shown in FIG. 3, the ESI source 314 can include a source 336 of pressurized gas (e.g., nitrogen, air, or a noble gas) that supplies a high velocity nebulizing gas flow to the nebulizer probe 338 that surrounds the outlet end of the electrospray electrode 316. As depicted, the electrospray electrode 316 protrudes from a distal end of the nebulizer probe 338. The pressured gas interacts with the liquid discharged from the electrospray electrode 316 to enhance the formation of the sample plume and the ion release within the plume for sampling by mass analyzer detector 320, e.g., via the interaction of the high-speed nebulizing flow and jet of liquid sample. The liquid discharged may include discrete volumes of liquid samples LS received from each reservoir 310 of the well plate 312. Each received liquid sample LS is instantly diluted by a solvent after being captured within the OPI, with a dilution factor of about 1000 times (as flow of the solvent moves the liquid samples LS from the OPI 304 to the ESI source 314, the solvent is also referred to herein as the transport liquid). The nebulizer gas can be supplied at a variety of flow rates, for example, in a range from about 0.1 L/min to about 20 L/min, which can also be controlled under the influence of controller 330 (e.g., via opening and/or closing valve 340).

It is appreciated that the flow rate of the nebulizer gas can be adjusted (e.g., under the influence of controller 330) such that the flow rate of liquid within the sampling OPI 304 can be adjusted based, for example, on suction/aspiration force generated by the interaction of the nebulizer gas and the analyte-solvent dilution as it is being discharged from the electrospray electrode 316 (e.g., due to the Venturi effect). The ionization chamber 318 can be maintained at atmospheric pressure, though in some examples, the ionization chamber 318 can be evacuated to a pressure lower than atmospheric pressure.

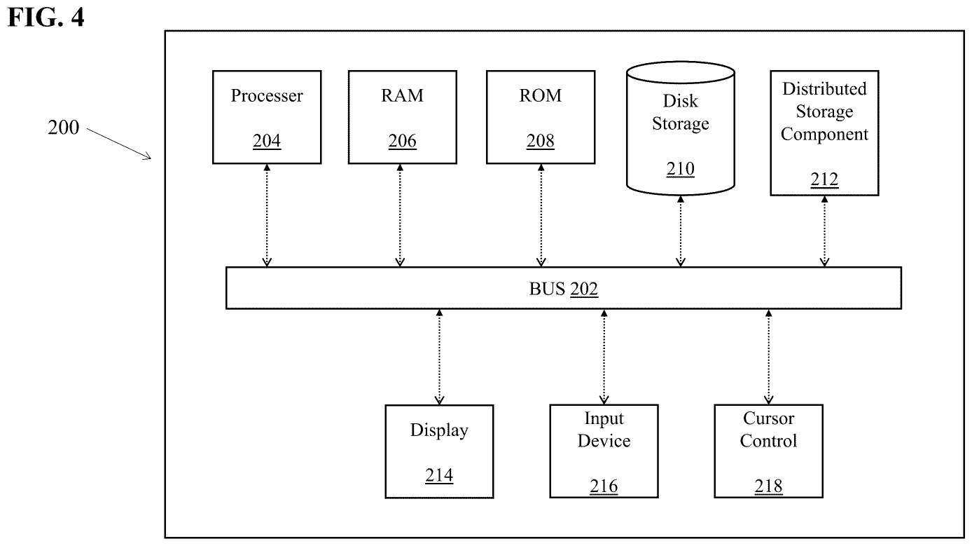

Now referring to FIG. 4, an example of the computing device 200 according to FIGS. 1 and 2 is illustrated and described. It is noted that the computing system 103 of the system 10 or 10′ may include a single computing device 200 or may include a plurality of distributed computing devices 200 in operative communication with components of a mass analysis instrument 100. In the illustrated example of FIG. 4, the computing device(s) 200 may include a bus 202 or other communication mechanism of similar function for communicating information, and at least one processing element 204 coupled with bus 202 for processing information. As is appreciated by those skilled in the relevant arts, such at least one processing element 204 may include a plurality of processing elements or cores, which may be packaged as a single processor or in a distributed arrangement. Furthermore, in some examples, a plurality of virtual processing elements 204 may be included in the computing device 200 to provide the control or management operations for the mass analysis instrument 100.

Computing device 200 may also include one or more volatile memory(ies) 206, which can for example include random access memory(ies) (RAM) or other dynamic memory component(s), coupled to one or more busses 202 for use by the at least one processing element 204. Computing device 200 may further include static, non-volatile memory(ies) 208, such as read only memory (ROM) or other static memory components, coupled to busses 202 for storing information and instructions for use by the at least one processing element 204. A storage component 210, such as a storage disk or storage memory, may be provided for storing information and instructions for use by the at least one processing element 204. As is appreciated, in some examples the computing device 200 may include a distributed storage component 212, such as a networked disk or other storage resource available to the computing device 200.

Computing device 200 may be coupled to one or more displays 214 for displaying information to a computer user. Optional user input devices 216, such as a keyboard and/or touchscreen, may be coupled to a bus for communicating information and command selections to the at least one processing element 204. An optional graphical input device 218, such as a mouse, a trackball or cursor direction keys for communicating graphical user interface information and command selections to the at least one processing element. The computing device 200 may further include an input/output (I/O) component, such as a serial connection, digital connection, network connection, or other input/output component for allowing intercommunication with other computing components and the various components of the mass analysis instrument 100.

In various examples, computing device 200 can be connected to one or more other computer systems a network to form a networked system. Such networks can for example include one or more private networks, or public networks such as the Internet. In the networked system, one or more computer systems can store and serve the data to other computer systems. The one or more computer systems that store and serve the data can be referred to as servers or the cloud, in a cloud computing scenario. The one or more computer systems can include one or more web servers, for example. The other computer systems that send and receive data to and from the servers or the cloud can be referred to as client or cloud devices, for example. Various operations of the mass analysis instrument 100 may be supported by operation of the distributed computing systems.

Computing device 200 may be operative to control operation of the components of the mass analysis instrument 100 and the sample delivery components 70, 80, 95, 105 through controller(s) 135 and to handle data generated by components of the mass analysis instrument 100 through the data processing system 400. In some examples, analysis results are provided by computing device 200 in response to the at least one processing element 204 executing instructions contained in memory 206 or 208 and performing operations on data received from the mass analysis instrument 100. Execution of instructions contained in memory 206 or 208 by the at least one processing element 204 can render the mass analysis instrument 100 and associated sample delivery components operative to perform methods described herein. Alternatively, hard-wired circuitry may be used in place of or in combination with software instructions to implement the present teachings. Thus, implementations of the present teachings are not limited to any specific combination of hardware circuitry and software.

The term “computer-readable medium” as used herein refers to any media that participates in providing instructions to processor 204 for execution. Such a medium may take many forms, including but not limited to, non-volatile media, volatile media, and transmission media. Non-volatile media includes, for example, optical or magnetic disks, such as disk storage 210. Volatile media includes dynamic memory, such as memory 206. Transmission media includes coaxial cables, copper wire, and fiber optics, including the wires that include bus 202.

Common forms of computer-readable media or computer program products include, for example, a floppy disk, a flexible disk, hard disk, magnetic tape, or any other magnetic medium, a CD-ROM, digital video disc (DVD), a Blu-ray Disc, any other optical medium, a thumb drive, a memory card, a RAM, PROM, and EPROM, a FLASH-EPROM, any other memory chip or cartridge, or any other tangible medium from which a computer can read.

Various forms of computer readable media may be involved in carrying one or more sequences of one or more instructions to processor 204 for execution. For example, the instructions may initially be carried on the magnetic disk of a remote computer. The remote computer can load the instructions into its dynamic memory and send the instructions over a telephone line using a modem. A modem local to computer system 200 can receive the data on the telephone line and use an infra-red transmitter to convert the data to an infra-red signal. An infra-red detector coupled to bus 202 can receive the data carried in the infra-red signal and place the data on bus 202. Bus 202 carries the data to memory 206, from which processor 204 retrieves and executes the instructions. The instructions received by memory 206 may optionally be stored on storage device 210 either before or after execution by processor 204.

In accordance with various examples, instructions configured to be executed by a processor to perform a method are stored on a computer-readable medium. The computer-readable medium can be a device that stores digital information. For example, a computer-readable medium includes a compact disc read-only memory (CD-ROM) as is known in the art for storing software. The computer-readable medium is accessed by a processor suitable for executing instructions configured to be executed.

### System for Sampling Event Control

In high throughput MS, the mass spectral information of each sample from the same plate is usually recorded continuously as one data file for data continuity and to facilitate data storage and processing. In many situations, the samples in a high throughput MS analysis are analyzed successively without interruption, and the resultant single large MS dataset is unsplit and unprocessed. For most high throughput mass spectrometry techniques, the signal duration may be stable over a same run, because the baseline peak widths in the chronogram are stable across the plate. Therefore, one way to control the sampling time is to set the ejection delay time to a constant value similar to the signal duration. For example, if a baseline peak width is equal to 1 second, the sample trigger frequency may be set to 1 second per sample. It is advantageous to be able to control the timing of the sample introduction. In various examples, the delay time may not be set to be too high, otherwise the throughput may be too low or the analysis may be too long, which in turn may reduce the analytical throughput of the MS system. In other examples, the delay time may also not be set to be too low, otherwise there may be a risk of overlapping MS signals from adjacent sampling events, which in turn may negatively affect the accuracy of signal integration.

However, this timing control method assumes the short/constant delay between the sampling triggering and the actual sampling event. When an extra delay is performed in a specific ejection, it would cause that particular ejection to have a longer delay time with the previous ejection, and a shorter delay time with the next ejection, causing the potential signal overlapping problem.

The example systems provided in the present disclosure advantageously include a timing control system or controller for sampling events that is able to control the sample ejector used in the MS process. For example, a set of operations can be performed by the central control system or controller to allow control of the system based on the extra delay, thereby automatically adjusting the triggering time of the post-delay ejection. Thus, after a certain sampling event is delayed, subsequent sampling events may be delayed and triggered to extract data more efficiently for subsequent analysis. As a result, the problem of potential signal overlapping may be solved.

Examples provided in this disclosure introduce an approach to automatically optimizing the ejection delay time. In the example illustrated in FIG. 2, a sampling event controlling system 110 includes a sample ejector 90 for ejecting a sample from a sample source 70, a processor operatively coupled to the sample ejector 90, a memory coupled to the processor, the memory storing instructions that, when executed by the processor, perform a set of operations including performing, via the processor, a sampling trigger A corresponding to a triggering time A; ejecting, via the sample ejector, a sample A from a sample source 70, wherein the sample ejection A corresponds to a sampling time A; determining, via the processor, a delay time based on the sampling time A and a sampling time B; and performing, via the processor, a sampling trigger C, wherein the sampling trigger C is performed based at least in part on the delay time. In some embodiments, the sampling event controlling system 110 may further include an ejection controller 92, and the ejection controller 92 includes the processor operatively coupled to the sample ejector 90. The ejection controller 92 may be in the form of electronic signal processors and in electrical communication with other subsystems within the system 10 or 10′. In some embodiments, the ejection controller 92 may further includes a clock module 9200.

### Automatic Control of Sampling Events

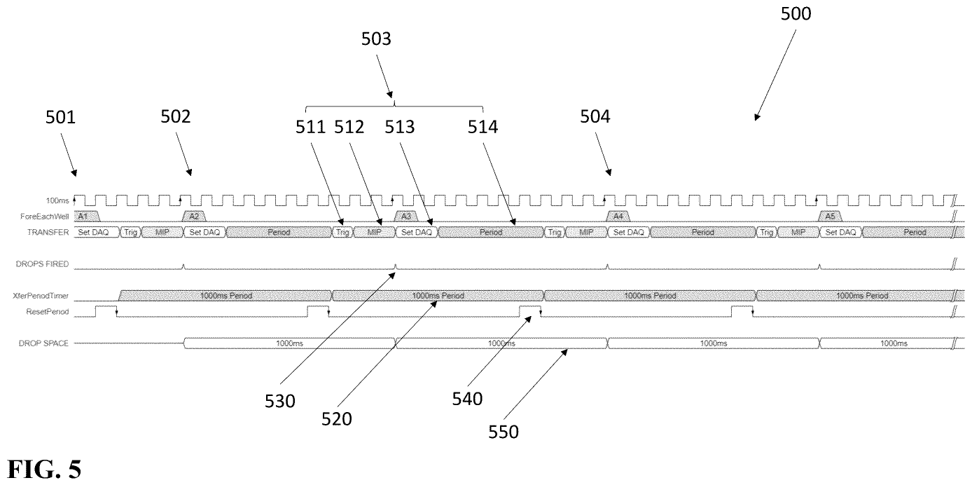

Now referring to FIG. 5, diagram of an explanatory timing waveform of sampling events according to various examples of the disclosure is illustrated and described. In some embodiments, there are multiple ejection cycles in the sampling events 500, e.g., a first ejection cycle 501, a second ejection cycle 502, a third ejection cycle 503, a fourth ejection cycle 504, and the like. As noted above, these ejection cycles may also be referred to as “A”, “B”, “C”, etc., and differentiated from each other accordingly. The time period of each ejection cycle may be manually or automatically decided based on the sampling requirements. In the example illustrated in FIG. 5, the time period of each ejection cycle is set to 1 second, except the first ejection cycle 501. There may be no referencing points for the first ejection 501.

In an example, the ejector can be the acoustic ejector 90 described above with respect to FIG. 2. Taking the third ejection cycle 503 as an example, a single ejection cycle may include the operation “Trig” 511, where the ejection cycle is triggered by a trigger signal. In some embodiments, the sampling event controlling system 110 may receive the trigger signal for sampling. In some embodiments, the trigger signal may be controlled by a clock module 9200 within the ejection controller 92. In some embodiments, the clock module 9200 may include a sampling timing generator circuit at a clock input, a positive power potential (a logic high level) at a data input, and/or a latched signal as an enable signal to the system for sample ejection. Accordingly, the sampling timing generator circuit may include circuitry configured to provide a set of pulses on the trigger signal during the time period. In other examples, the trigger signal may be controlled by a clock module separate from the ejection controller 92. In other examples, the trigger signal may be controlled by computer software. In some embodiments, duration of the trigger signal may be 1-2 ms.

Various examples include operation “MIP” 512, where an acoustic energy optimization is performed. In some embodiments, the sampling event controlling system 110 is intended to encompass various ways of optimizing the acoustic energy and acoustic ejection processes. For example, the ADE, as described in FIG. 3, may be utilized for characterization of a fluid in a reservoir, to measure the height of the fluid meniscus, as well as other properties, such as fluid volume, viscosity, density, surface tension, composition, acoustic impedance, acoustic attenuation, speed of sound in the fluid, etc., any or all of which can then be used to determine optimum parameters for droplet ejection, including acoustic power, acoustic frequency, tone burst duration, and/or the F-number of the focusing lens. As another example, acoustic interrogation processes can be used to optimize the relative position of the acoustic ejector and a fluid-containing reservoir in a focus-activated acoustic ejection system. An additional example is a method for optimizing the amplitude of the acoustic radiation used to eject fluid droplets, by analyzing the waveforms of acoustic radiation reflected from surfaces within the reservoir prior to ejection. Droplet size and consistency can be ensured and variations in reservoir properties can be controlled.

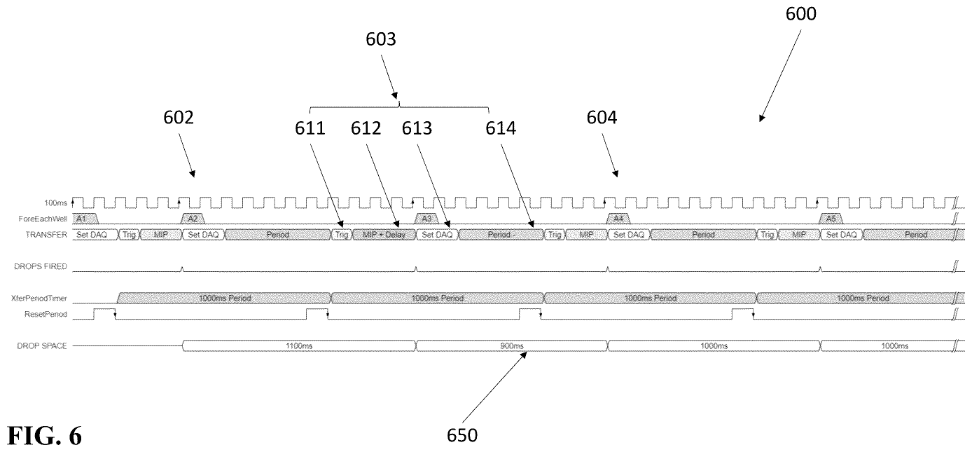

Other examples include operation “DROPS FIRED” 530, where the acoustic ejection is performed. After the acoustic energy optimization is performed, the acoustic ejector fires a sample and a DROPS FIRED signal 530 indicating the sample ejection occurs. Here taking the third ejection cycle 503 as an example, the acoustic ejector fires the third sample and a DROPS FIRED signal 530 indicating the sample ejection occurs. In some embodiments, the “Drop Space” duration 550 may be determined based on adjacent “DROPS FIRED” 530. Here taking the third ejection cycle 503 as an example, the “Drop Space” duration 550 begins from the “DROPS FIRED” 530 of the third ejection cycle 503 and ends from the “DROPS FIRED” 530 of the fourth ejection cycle 504. In some embodiments, the “Drop Space” duration 550 is constant if no delay occurs during the sampling events. In some embodiments, the “Drop Space” duration 550 may vary based on the delay of the sampling events and will be further described below in FIG. 6.

Other examples include operation “Set DAQ” 513, where the preparations for the next ejection cycle are performed. Here taking the third ejection cycle 503 as an example, the preparations for the fourth ejection 504 are performed during the operation “Set DAQ” 513. In some embodiments, the operation “Set DAQ” 513 may include a stage moving procedure. During the stage moving procedure, the sample handler 80 may transfer a well plate from the sample preparation system 101 to the ejection system 102. More specifically, during stage moving procedure, the sample handler 80 may transfer the well plate to a plate handler 95 of the ejection system 102, or translate the well plate in an x-y plane to align wells of the well plate with the ejector 90 and/or the capture probe 105. In some embodiments, the stage moving procedure may take 100-200 ms.

In examples, in operation “Period” 514, the ejector waits for the next ejection cycle. Here taking the third ejection cycle 503 as an example, the ejector waits for the fourth ejection cycle 504 during the operation “Period” 514. In some embodiments, the “Period” end points between adjacent ejection cycles, namely the “XferPeroidTimer” duration 520, is controlled to be the same as the pre-defined reference delay time, and the pre-defined reference delay time may be 1000 ms. Here, the “XferPeroidTimer” duration 520 lasts between the “Period” end points of the third ejection cycle 503 and the “Period” end point of the fourth ejection cycle 504. In another embodiment, the “XferPeroidTimer” duration 520 lasts between the “MIP” start points of adjacent ejection cycles and the “XferPeroidTimer” duration 520 is controlled to be the same as the pre-defined reference delay time, and the pre-defined reference delay time may be 1000 ms. For example, the “XferPeroidTimer” duration 520 lasts between the “MIP” start point of the third ejection cycle 503 and the “MIP” start point of the fourth ejection cycle 504. In another embodiment, a clock reset signal 540 is received during a reset period at the end of the operation “Period” 514.

In addition, the ejector may be any other type of suitable ejector, such as a pneumatic ejector, or other type of contactless ejector. In some embodiments, a single ejection cycle may include the following operations. One operation includes “Trig” 511, where the ejection cycle is triggered by the trigger signal. Yet another operation includes “DROPS FIRED” 530, where the acoustic ejection is performed. Another operation includes “Set DAQ” 513, where the acoustic ejection is performed. Yet another operation includes “Period” 514, where the ejector waits for the next ejection cycle.

However, as described earlier in the system for sampling event control, when an additional delay occurs for a particular ejection, such as software and/or hardware delay occurs in operation “MIP” 512 and causing longer duration of opertation “MIP” 512, it causes this particular ejection to have a longer delay time with the previous ejection and a shorter delay time with the next ejection, creating an above-mentioned potential signal overlap problem.

FIG. 6 is a diagram illustrating a timing waveform of delayed sampling events. In some embodiments, there are multiple ejection cycles in the sampling events 600, e.g., a second ejection cycle 602, a third ejection cycle 603, a fourth ejection cycle 604. The time period of each ejection cycle is manually or automatically decided based on the sampling requirements. Here, the time period of each ejection cycle is set to 1000 ms.

The ejector can be an acoustic ejector described above, and a single ejection cycle may include the following operations. One such operation includes “Trig” 611, where the ejection cycle is triggered by the trigger signal. Another operation includes “MIP” 612, where an acoustic energy optimization is performed. Yet another operation includes “DROPS FIRED” 530, where the acoustic ejection is performed. Yet another operation includes “Set DAQ” 613, where the preparations for the next ejection cycle is performed. Yet another operation includes “Period” 614, where the ejector waits for the next ejection cycle.

Here, the third ejection cycle 603 has an extra delay during the operation of “MIP” 612. As a result, a “Drop Space” duration 650 between the third sampling ejection and the fourth sampling ejection is 900 ms and shorter than the pre-set delay time 1000 ms, causing the signal integration challenge for these affected signals.

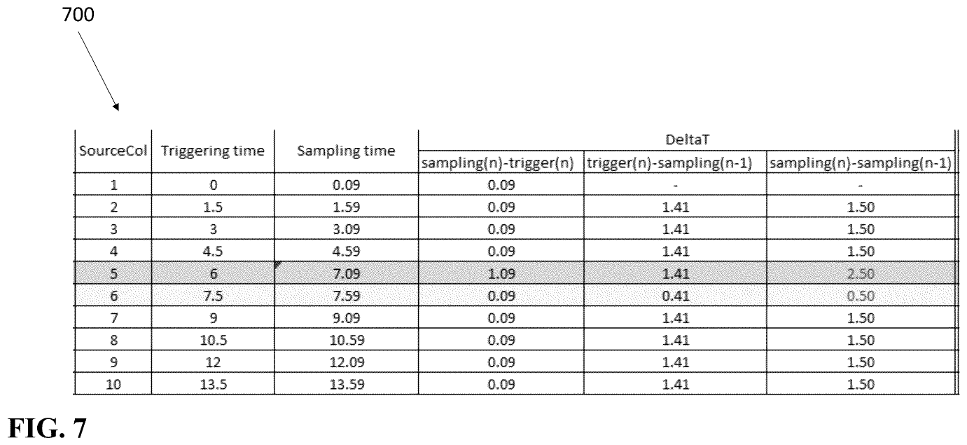

FIG. 7 is a table illustrating time stamps of sampling events. The time stamps of ten ejection cycles are shown in Table 700 (the unit is second, “s”). In some embodiments, the time period between triggering time and sampling time, including the operation of “Trig” and the operation of “MIP”, is constantly 0.09 s for each ejection cycle except the fifth ejection cycle. Here, an additional delay occurs for the fifth ejection cycle, and the time period between triggering time and sampling time is changed to be 1.09 s. However, the triggering time of the sixth ejection cycle (Ttriggerₙ) is still unchanged. As a result, the time period between the sampling time of the fifth ejection cycle and the sampling time of the sixth ejection cycle (Tsamplingₙ₋₁−Tsamplingₙ₋₂) is reduced to 0.5 s, which will likely result in the sensed sampling signals overlapping each other.

Due to the large quantity of data, any deficiency in data processing may be detrimental to the accuracy of analyte identification and/or to the confidence of the analytical results. Each deficiency needs to be separately analyzed and modified, which can lead to significant challenges and inefficiencies, including requirement of manual interaction and intervention for many of the operations.

### Determining Sample Ejection Timing

In some embodiments, a sampling triggering timing control method that solves the challenge of the overlapped signal by utilizing the time stamps of the actual sampling events is introduced.

In some embodiments, the triggering time to trigger a sampling (Ttriggerₙ) is not only determined by the triggering time of the previous event (Ttriggerₙ₋₁), the pre-defined ejection-to-ejection delay time (Tdelay), but also the delay time between the previous two sampling events (Tsamplingₙ₋₁−Tsamplingₙ₋₂). One example of setting the triggering time Ttriggern may be Equation (1) and (2):

Ttriggerₙ=Ttriggerₙ₋₁+(Tsamplingₙ₋₁−Tsamplingₙ₋₂), if (Tsamplingₙ₋₁−Tsamplingₙ₋₂)≥Tdelay (Equation 1)

Ttriggerₙ=Ttriggerₙ₋₁+Tdelay, if (Tsamplingₙ₋₁−Tsamplingₙ₋₂)<Tdelay (Equation 2)

In Equations (1) and (2), “n” is the sequence number of sampling cycle, Ttrigger is the triggering time, Tsampling is the actual sampling time, and Tdelay is the pre-defined ejection-to-ejection delay. For example, if the time period between the sampling time of the sixth sampling cycle (Tsampling₆) and the sampling time of the fifth sampling cycle (Tsampling₅) is smaller than the pre-defined ejection-to-ejection delay time (Tdelay), then the triggering time of the seventh sampling cycle (Ttrigger₇) is equal to the result of the triggering time of the sixth sampling cycle (Ttrigger₆) plus the pre-defined ejection-to-ejection delay time (Tdelay). For example, if the time period between the sampling time of the sixth sampling cycle (Tsampling₆) and the sampling time of the fifth sampling cycle (Tsampling₅) is larger than the pre-defined ejection-to-ejection delay time (Tdelay), then the triggering time of the seventh sampling cycle (Ttrigger₇) is equal to the result of the triggering time of the sixth sampling cycle (Ttrigger₆) plus the time period between the sampling time of the sixth sampling cycle (Tsampling₆) and the sampling time of the fifth sampling cycle (Tsampling₅).

To further control the sampling event operation when an extra delay is performed to the first ejection, which might lead to signal overlapping between the first and second ejection, a pre-defined system ejection with Tdelay_{reference} could be implemented prior to the first ejection to provide the anchor point Tsamplingₙ₋₂ and initiate the second ejection with Ttriggerₙ. Tdelay_{reference} defines the sufficient delay between a system barcode ejection and the first ejection to avoid potential signal overlapping in between. The system barcode ejection is used to identify the first ejection in a series of sequential samples. An example system barcode ejection is illustrated and described in greater detail in PCT Application No. PCT/IB2021/054401, filed May 22, 2020, entitled “Identification of a first sample in a series of sequential samples,” and the disclosures of the system barcode ejection are entirely incorporated herein by reference. One example of setting the triggering time Ttriggerₙ could be Equations (3)-(7):

When n=1, no algorithm to be applied for the first sampling cycle, (Equation 3)

When n=2, Ttrigger₂=Ttrigger₁+(Tsample₁−Tsampling_{reference}), if (Tsampling₁−Tsampling_{reference})>Tdelay_{reference} (Equation 4)

Ttrigger₂=Ttrigger₁+Tdelay, if (Tsampling₁−Tsampling_{reference})<=Tdelay_{reference} (Equation 5)

When n≥3, Ttriggerₙ=Ttriggerₙ₋₁+(Tsamplingₙ₋₁−Tsamplingₙ₋₂), if (Tsamplingₙ₋₁−Tsamplingₙ₋₂)>Tdelay (Equation 6)

Ttriggerₙ=Ttriggerₙ₋₁+Tdelay, if (Tsamplingₙ₋₁−Tsamplingₙ₋₂)<=Tdelay. (Equation 7)

In Equations (3)-(7), “n” is the sequence number of the sampling cycle, Ttrigger is the triggering time, Tsampling is the actual sampling time, Tdelay is the pre-defined ejection-to-ejection delay, Tdelay_{reference} is the pre-defined reference delay, and Tsampling_{reference} is the pre-defined reference sampling time. When the first sampling cycle is performed, no algorithm will be applied for the first sampling cycle.

When the second sampling cycle is performed, the time period between the sampling time of the first sampling cycle (Tsampling₁) and the pre-defined reference sampling time (Tsampling_{reference}) is calculated. The triggering time of the second sampling cycle (Ttrigger₂) is decided based on the result of (Tsample₁−Tdelay_{reference}). If this time period is larger than the pre-defined reference delay (Tdelay_{reference}), then the triggering time of the second sampling cycle (Ttrigger₂) is the result of the triggering time of the first sampling cycle (Ttrigger₁) plus the time period between the sampling time of the first sampling cycle and the pre-defined reference sampling time (Tsampling_{reference}); if this time period is smaller than the pre-defined reference delay (Tdelay_{reference}), then the triggering time of the second sampling cycle (Ttrigger₂) is the result of the triggering time of the first sampling cycle (Ttrigger₁) plus the pre-defined reference delay (Tdelay_{reference}).

When the third (or fourth, fifth, and so on) sampling cycle is performed, the time period between the sampling time of the n-1 sampling cycle (Tsamplingₙ₋₁) the sampling time of the n-2 sampling cycle (Tsamplingₙ₋₂) is calculated. Take the seventh sampling cycle as an example, if the time period between the sampling time of the sixth sampling cycle (Tsampling₆) and the sampling time of the fifth sampling cycle (Tsampling₅) is smaller than the pre-defined ejection-to-ejection delay time (Tdelay), then the triggering time of the seventh sampling cycle (Ttrigger₇) is equal to the result of the triggering time of the sixth sampling cycle (Ttrigger₆) plus the pre-defined ejection-to-ejection delay time (Tdelay). For example, if the time period between the sampling time of the sixth sampling cycle (Tsampling₆) and the sampling time of the fifth sampling cycle (Tsampling₅) is larger than the pre-defined ejection-to-ejection delay time (Tdelay), then the triggering time of the seventh sampling cycle (Ttrigger₇) is equal to the result of the triggering time of the sixth sampling cycle (Ttrigger₆) plus the time period between the sampling time of the sixth sampling cycle (Tsampling₆) and the sampling time of the fifth sampling cycle (Tsampling₅).

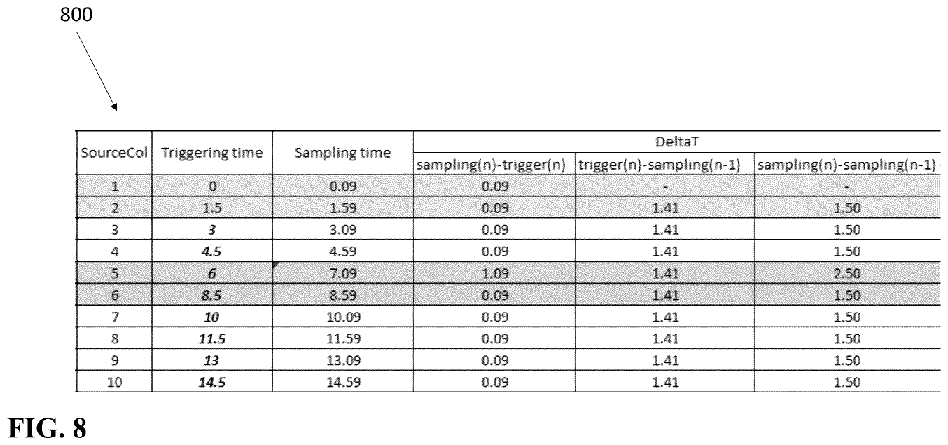

FIG. 8 is a table illustrating time stamps of another sampling events. The time stamps of ten ejection cycles are shown in Table 800 (the unit is second, “s”). In some embodiments, the time period between triggering time and sampling time, including the operation of “Trig” and the operation of “MIP”, is constantly 0.09 s for each ejection cycle except the fifth ejection cycle. Here, an additional delay occurs for the fifth ejection cycle, and the time period between triggering time and sampling time is changed to be 1.09 s. If the triggering time of the sixth ejection cycle is still unchanged, as illustrated in FIG. 7, the time period between the sampling time of the fifth ejection cycle and the sampling time of the sixth ejection cycle is reduced to 0.5 s, which will likely result in the sensed sampling signals overlapping each other.

The disclosure also introduces a method for automatically controlling a sampling event, and the triggering time of the sixth ejection cycle (Ttrigger₆) is not only determined by the triggering time of the previous event (Ttrigger₅), the pre-defined ejection-to-ejection delay time (Tdelay), but also the delay time between the previous two sampling events (Tsampling₅−Tsampling₄). Thus, the sixth sampling trigger is performed based at least part on the delay time, and the triggering time of the sixth ejection cycle (Ttrigger₆) is set to 2.5 s from the triggering time of the fifth ejection cycle (Ttrigger₅).

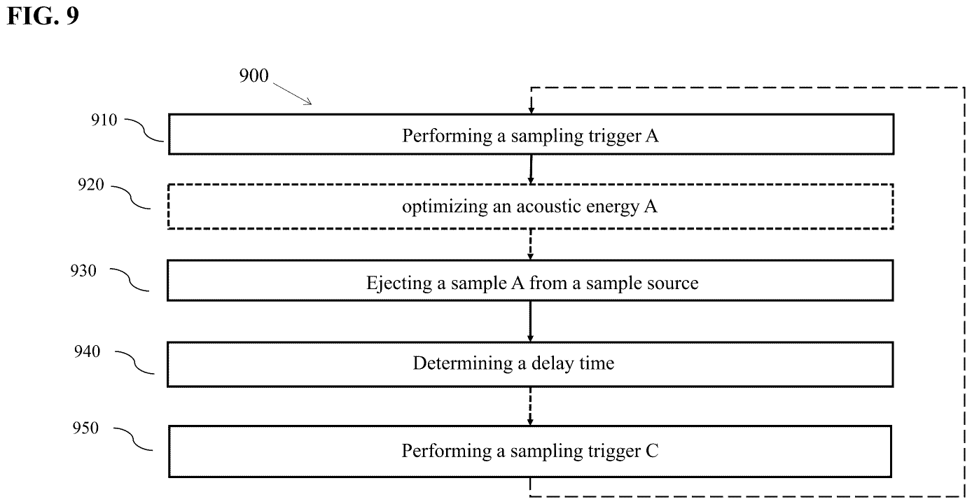

FIG. 9 represents a flowchart illustrating a method for automatically controlling a sampling event, in accordance with various examples of the disclosure. In various examples, the method 900 includes performing a sampling trigger A 910 corresponding to a triggering time A, ejecting a sample A from a sample source 930, wherein the sample ejection A corresponds to a sampling time A, determining a delay time 940 based on the sampling time A and a sampling time B, and performing a sampling trigger C 950, wherein the sampling trigger C is performed based at least in part on the delay time. In various examples, the method 900 may also include operation 920 during which an acoustic energy A is optimized.

In other examples, the sampling trigger C is performed after the delay time from the triggering time A. In other examples, operation 940 includes calculating a difference between the sampling time A and the sampling time B, and determining the delay time based on the difference. In other examples, determining the delay time based on the difference may be performed by comparing the difference and a preset threshold, and setting the delay time based on the comparison of the difference and the preset threshold. In various other examples, determining the delay time may be performed, as in operation 940, via Equations (3)-(7) discussed above. In various examples, the delay time is at least equal to a preset threshold, e.g., 1.5 s as the pre-defined ejection-to-ejection delay time. In various examples, a difference between the triggering time C and the sampling time A is a constant, e.g., 1.41 s.

In other examples, operation 920 includes optimizing an acoustic energy A after performing the sampling trigger A 910. In various examples, operation 930 during which the sample A is ejected after the acoustic energy optimization A 920. For example, optimizing an acoustic energy A 920 is performed after performing the sampling trigger A 910 and before ejecting a sample A from a sample source 930.

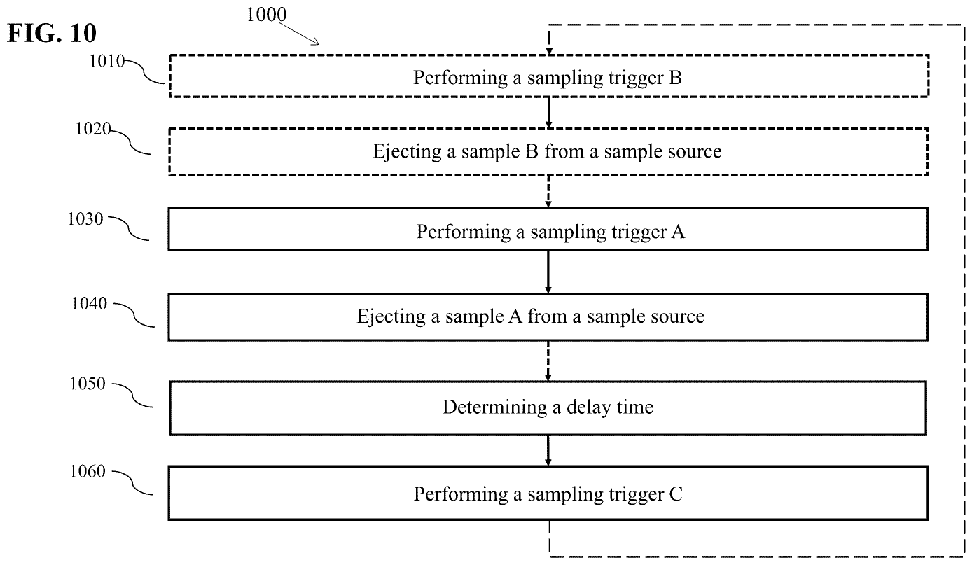

FIG. 10 represents a flowchart illustrating another method for automatically controlling a sampling event, in accordance with various examples of the disclosure. In various examples, the method 1000 includes performing a sampling trigger A 1030 corresponding to a triggering time A, ejecting a sample A from a sample source 1040, wherein the sample ejection A corresponds to a sampling time A, determining a delay time 1050 based on the sampling time A and a sampling time B corresponding to a sample ejection B, and performing a sampling trigger C 1060, wherein the sampling trigger C is performed based at least in part on the delay time. In various examples, the method 900 may also include operation 1010 during which a sampling trigger B is performed. In various examples, the method 900 may also include operation 1020 during which a sampling B is ejected from a sample source. In various examples, the sample ejection B 1020 is performed before the sample ejection A 1040. In various examples, the method 900 may also include operation 1010 during which a sampling trigger B is performed. In various examples, the sampling trigger B 1010 is performed before the sample ejection B 1020. In various examples, operation 920 includes determining a delay time based on the sampling time A and a sampling time B, and the sampling time B is a reference sampling time.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus. Some or all of the method steps may be executed by (or using) a hardware apparatus, like for example, a processor, a microprocessor, a programmable computer or an electronic circuit. In some examples, some one or more of the most important method steps may be executed by such an apparatus.

Generally, examples of the present disclosure can be implemented through the use of computer program products with program codes, the program codes being operative for performing the operations described herein when the computer program product runs on a computer such as may be used to embody any or all of controllers such as, 135, 82, 92, 96, 107, 127, or 330.

Although various examples and examples are described herein, those of ordinary skill in the art will understand that many modifications may be made thereto within the scope of the present disclosure. Accordingly, it is not intended that the scope of the disclosure in any way be limited by the examples provided.

1. A method for automatically controlling a sampling event, the method comprising:
performing a sampling trigger A corresponding to a triggering time A;
ejecting a sample A from a sample source, wherein the sample ejection A corresponds to a sampling time A;
determining a delay time based on the sampling time A and a sampling time B; and
performing a sampling trigger C, wherein the sampling trigger C is performed based at least in part on the delay time.

2. The method of claim 1, wherein the sampling trigger C is performed after the delay time from the triggering time A.

3. The method of claim 1, wherein determining a delay time comprises:
calculating a difference between the sampling time A to the sampling time B; and
determining the delay time based on the difference.

4. The method of claim 3, wherein determining the delay time based on the difference comprises:
comparing the difference and a preset threshold; and
setting the delay time based on the comparison of the difference and the preset threshold.

5. The method of claim 1, wherein the delay time is at least equal to a preset threshold.

6. The method of claim 1, wherein the sampling time B corresponds to a sample ejection B, wherein the sample ejection B is performed before the sample ejection A.

7. The method of claim 6, wherein the sampling trigger B is performed before the sample ejection B.

8. The method of claim 1, wherein the sampling time B is a reference sampling time.

9. The method of claim 1, further comprising:
optimizing an acoustic energy A after performing the sampling trigger A.

10. The method of claim 8, wherein the sample A is ejected after optimzing the acoustic energy A.

11. The method of claim 1, wherein a difference between the sampling trigger C and the sampling time A is a constant.

12. A sampling event controlling system comprising:
a sample ejector for ejecting a sample from a sample source;
a processor operatively coupled to the sample ejector;
a memory coupled to the processor, the memory storing instructions that, when executed by the processor, perform a set of operations comprising:
performing, via the processor, a sampling trigger A corresponding to a triggering time A;
ejecting, via the sample ejector, a sample A from a sample source, wherein the sample ejection A corresponds to a sampling time A;
determining, via the sample ejector, a delay time based on the sampling time A and a sampling time B; and
performing, via the processor, a sampling trigger C, wherein the sampling trigger C is performed based at least in part on the delay time.

13. The system of claim 12, wherein the sampling trigger C is performed after the delay time from the triggering time A.

14. The system of claim 12, wherein the set of operations comprises determining a delay time by:
calculating a difference between the sampling time A to the sampling time B;
comparing the difference and a preset threshold; and
setting the delay time based on comparing the difference and the preset threshold.

15. (canceled)

16. The system of claim 12, wherein the delay time is at least equal to a preset threshold.

17. The system of claim 12, wherein the sampling time B corresponds to a sample ejection B, wherein the sample ejection B is performed before the sample ejection A.

18. (canceled)

19. (canceled)

20. The system of claim 12, the set of operations further comprises:
optimizing an acoustic energy A after performing the sampling trigger A.

21. The system of claim 20, wherein the sample A is ejected after optimizing the acoustic energy A.

22. (canceled)

23. The system of claim 12, further comprising:
a clock module for perform the sampling trigger.

24. The system of claim 23, wherein the clock module comprises at least one clock circuit.
